(19) United States
(12) Patent Application Publication
(10) Pub. No.: US 2006/0004664 A1
(43) Pub. Date: Jan. 5, 2006

(54) Internet-based on-demand digital program delivery system and method

(75) Inventors: William Ruhnke, Brooklyn, NY (US); Lowell Feuer, Englewood, NJ (US)

Correspondence Address: SILLS CUMMIS EPSTEIN & GROSS P.C., ONE RIVERFRONT PLAZA, IP DEPARTMENT, NEWARK, NJ, 07102, US

(73) Assignee: KlikVu, Inc.

(21) Appl. No.: 11/158,878

(22) Filed: Jun. 22, 2005

Related U.S. Application Data
(60) Provisional application No. 60/521,797, filed on Jul. 5, 2004.

(51) Int. Cl. G06Q 99/00

(52) U.S. Cl. 705/51

(57) ABSTRACT

A system and method for providing on demand service to owners of video and/or audio program rights to offer digital versions of those programs to web site visitors. The system is an Application Service Provider (ASP) model, whereby the services are provided to the video and/or audio owners over the World Wide Web where no specific software need reside with the video and/or audio owners. Video or audio programs from the owners, once converted to an appropriate digital form, are streamed over the Internet or other IP networks for viewing in real-time, direct from video and/or audio servers of the system, by viewers who have purchased the right to view them through a web site that does not have rights to the digital programs. E-commerce transaction processing is provided on behalf of the video and/or audio owner, and revenue is appropriately conveyed to the owner and/or the web site.

This application claims the benefit of provisional application Ser. No. 60/521,797, filed on Jul. 5, 2004, the contents of which are incorporated herein by this reference.

### BACKGROUND OF THE INVENTION

1. Field of the Invention

The present invention relates to on-line services for consumers, and more specifically, to a system and method of providing on demand digital video and audio programs to visitors on a particular web site, screen and/or channel.

2. Prior Art

The entertainment industry imbues video and/or audio programs with rights of different types, and such rights may be held by one owner or shared with others who have an interest in the video and/or audio property or who made a contribution to the video and/or audio program's creation. In the past, any form of distribution or exhibition of the video and/or audio program required that the distributor or exhibitor be granted the specific rights to distribute or exhibit the video and/or audio, by the rights holders, and the distributor or exhibitor could be held liable if the rights were not properly secured from all the rights holders of the video and/or audio property.

Many video and/or audio programs, though the provider may be confident that all the rights are within their power to grant, may require that extensive research or legal documentation be performed by or provided to the distributor or exhibitor to minimize the risk that the distributor or exhibitor may be liable for rights disputes. Often such legal documentation is not available in a suitable form, and the distributor or exhibitor cannot quantify their exposure to liability.

Traditionally, web sites that wished to offer video and/or audio programs to their visitors would obtain rights to exhibit the video and/or audio programs over the Internet, and may go to some expense to do so, prior to any sales. Likewise, the video and/or audio provider would negotiate the conveyance of Internet exhibition rights to the web site, typically giving up their right to pass such rights to another, often compromising their ability to sell the video and/or audio program to other distribution channels. Moreover, Internet exhibition rights may not be well documented in the various contracts the filmmaker executes with those who contribute to the making of the video and/or audio program, making it legally risky for the video and/or audio owner to pass Internet exhibition rights as a class to a web site or to any distributor.

Therefore, it is risky for the video and/or audio programs to sell the programs to other distribution channels, and for the distributor/exhibitor to accept distribution of the video and/or audio programs without avoiding liability. Recently, the emergence of application service providers (ASP) has led to legal decisions upholding the ASP'S role as a conduit between parties, without liability for the conduct of those parties.

### SUMMARY OF THE INVENTION

Therefore, it is an object of the present invention to provide sales, distribution and exhibition services, but to not be held liable for any rights disputes between parties. The present invention, as an ASP, matches buyers with sellers, and provides them with transaction services, but does not assume ownership of the seller's item(s) and does not resell them, and therefore, is not a party to the sale.

The present invention provides contracted services to the presumed rights holder, and the rights holder conveys the right to view the video and/or audio program directly to the viewing consumer, aided by the mechanism of the present invention.

The present invention empowers the video and/or audio owner to grant viewing rights to one user at a time, retaining all other rights. Internet exhibition rights as a class do not have to be codified or documented, as no conveyance of this class of rights is required. By providing sales, distribution, and exhibition services as an application service provider, the present invention is not liable for rights disputes.

Accordingly, a system for merchandising digital programs over the World Wide Web is provided. The system for merchandising digital programs comprises a device having a storing means for storing one or more digital programs provided by an owner of the rights to the digital programs, ordering means for ordering one or more digital programs by a user from a web site through the device, the web site not having rights to the digital programs, and authorization means for obtaining authorization for the user from the owner to obtain the ordered one or more digital programs, wherein the one or more digital programs ordered by the user are streamed from the device directly to the user.

The system for providing digital programs over the world wide web further comprises a purchasing means for purchasing the one or more digital programs. The system can further comprise a billing means for providing payouts to the owner and the web site based on the amounts or percentages the owner and the web site are to receive.

Further, a method for providing digital programs over the world wide web is provided, the method comprising storing one or more digital programs provided by an owner of the rights to the digital programs in a device, providing an ordering means to a user to order one or more digital programs from a web site through the device, the web site not having rights to the digital programs, obtaining authorization for the user to obtain the ordered one or more digital programs, and streaming the one or more digital programs ordered by the user from the device directly to the user.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a block diagram a first embodiment of the video and/or audio ordering and delivering system according to the present invention.

FIG. 2 illustrates a block diagram a second embodiment of the video and/or audio ordering and delivering system according to the present invention.

FIG. 3 illustrates a block diagram a third embodiment of the video and/or audio ordering and delivering system according to the present invention.

### DETAILED DESCRIPTION OF THE INVENTION

Although this invention is applicable to numerous and various types of online transactions, it has been found particularly useful in the environment of sales, distribution and exhibition of on-demand digital video and/or audio programs. Therefore, without limiting the applicability of the invention to the above, the invention will be described in such environment.

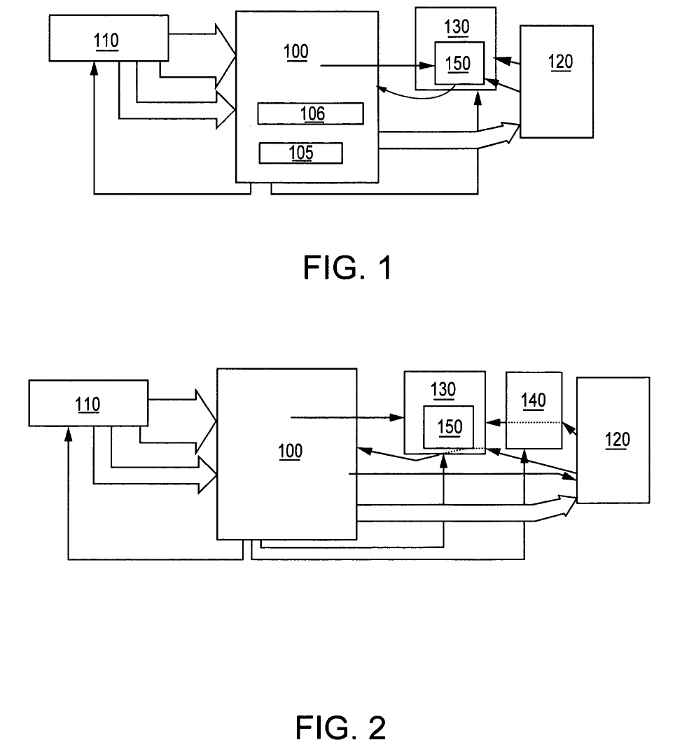

FIG. 1 illustrates a schematic representation of a digital video and/or audio delivering method and system in accordance with the present invention. An owner 110 of video and/or audio provides video and/or audio in digital form to a device 100, and also provides rules regarding the rights to view the video and/or audio to the device 100. An online order form (not shown) may be generated for the owner to fill out with the necessary information prior to providing the rights to view the video and/or audio to the device 100. This order form could release the device 100 or web site 130 from any liability. The owner 110 can be an artist who created the video and/or audio themselves, or a company who has acquired the rights to the video and/or audio. The device 100 comprises a storing means 105, such as servers, that store the video and/or audio. Typically, the video and/or audio program is digitized in the Windows Media video or audio format, encrypted with Microsoft Digital Rights Management (DRM), and stored on Windows Media servers that are connected to the Internet. Other types of encoding or encryption may also be used.

The device 100 also stores an order form 150 that is provided to an ordering web site 130. The ordering web site 130 can display an e-commerce shopping cart that offers one or more video and/or audio programs from the various video and/or audio programs that are stored in the servers of the device 100. The shopping cart is promulgated from the device 100, but can be accessed by visiting an ordering web site 130.

A visitor 120 of the web site 130 visits the web site 130 and is able to complete the order form 150 to purchase and view the video and/or audio. The device 100 also has a purchasing means where the web visitor 120 is provided payment options to purchase the rights to view the digital programs. After the web visitor 120 completes the order form 150 and provides payment information (such as credit card number), and the purchase is completed, this information is relayed to the device 100 through the ordering web site 130. A web visitor 120 that transacts with the shopping cart to purchase viewing of a video and/or audio program is provided DRM authorization on behalf of the owner 110 through an authorization means 106. The video and/or audio is then streamed to the web visitor 120, so that it can be viewed or listened to immediately, rather than by downloading. The web visitor 120 can then view the streaming video or listen to the streaming audio over the Internet connection, directly from the servers 105 of the device 100.

The servers are connected to robust internet connections to provide streaming video and/or audio to web visitors 120 who may be connecting from anywhere on the Internet. Each purchase by a web visitor 120 is completed through an ordering web site 130 and by the device 100, on behalf of the video and/or audio rights owner 110. Permission to view the video and/or listen to the audio program may be based upon the one-time purchase of a viewing (so called “pay-per-view”), or a subscription, membership, or other authorized status. A viewer may also purchase a DVD or CD, or rights to download and save the digital video and/or audio program, through the web site 130 and device 100.

All such permissions and purchases are granted and maintained by the device 100. The device 100 can also be provided with a billing means that provides payouts to the owner 110, and to the ordering web site 130, depending on the amounts or percentages of the total sale that the owner 110 and the ordering web site 130 are to receive. The billing means of the device 100 can also charge the owner 110 for the use of the device 100, or deduct the amount owed to the device 100 from the payout to be received by the owner 110.

A second embodiment of the present invention is provided in FIG. 2. This embodiment is similar to the first embodiment, except that a referral web site 140 is used that wishes to merchandise video and/or audio programs for which they are nor an authorized ordering site such as web site 130. The referral web site 140 may become an affiliate/referral web site, and relay the web visitor 120 to the ordering web site 130 for the transaction when the web visitor 120 visits the referral web site 140.

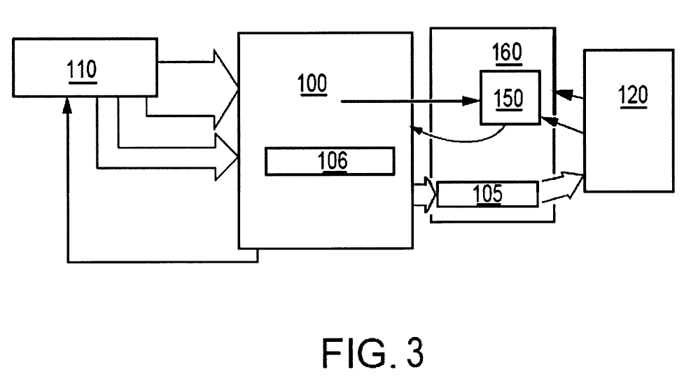

A third embodiment of the present invention is provided in FIG. 3. In this embodiment, the servers 105 can be connected to or located within an Internet Service Provider's (ISP's) central office 160, with the intent that the servers provide streaming video and/or audio to the ISP's own customers. The ISP would manage a purchase of the viewing of a video program or listening to an audio program, and payment may be included in the ISP's billing of their customers. The device 100 would maintain a record of all such payments and purchases.

The present invention provides several advantages that solve the problems with prior art methods. The present invention provides a system that permits an owner 110 of video and/or audio exhibition rights to merchandise viewings of the video and/or audio program from one or more web sites without transferring exhibition rights to the web site. The present invention provides services to the video and/or audio rights owner such as video and/or audio hosting on video and/or audio servers, for streaming delivery to viewers, connections to the video and/or audio servers to access the Internet or other IP-type networks, e-commerce order forms that can be propagated onto one or more web sites, e-commerce transactions, DRM authorizations for viewing, affiliate/referral tracking to identify sales that originate from other web sites, payouts of portions of the e-commerce transaction revenues generated to one or more owners 110, and payouts of portions of the e-commerce transaction revenues to one or more web sites that generate the sale.

Further, the video and/or audio rights owner 110 does not incur the costs of building, maintaining, or retaining the services of a commercial service for video and/or audio hosting, e-commerce software, credit card merchant accounts, or digital rights management encryption and DRM authorization license issuances. The ordering web site 130 does not incur the costs of obtaining exhibition rights, or the costs of video and/or audio hosting, e-commerce software, or credit card merchant accounts.

The invention can also have customizable metadata, such as criteria for matching content to websites. Prior art customizable metadata typically describes the title, the artist or principal actors, the year made, and one or two lines about the story, if applicable. The present invention provides customizable metadata that describes thematic, point-of-view, subject matter and other esoteric references triggered by the film or video property. These metadata references will be further customized to be accessible by web video search engines and targeted websites. Usually, the filmmaker or owner themselves, who knows the film most intimately, will do the first part of the customization. But the curator, or showcase webmaster, can perform the secondary customization.

The invention also provides for contextual syndication, where there is a syndication of videos to search engines and websites whose natural audience has a native interest in the themes of the video being searched, and therefore will be more likely to purchase a viewing of that video or other videos in a related theme. Contextual syndication allows for the aggregation and categorization of the content by the device 100, and the device 100 matches the most relevant videos and/or music with the users, depending on specific user preferences. Advertisements can be sold based on this contextual reference.

The present invention can also provide a self-contained portable system for accepting a video and/or audio input, and generating three simultaneous streams of video with audio output to a network. The system is compact and rugged, such that it can be carried or shipped to a video and/or audio production and easily accommodated in an existing video and/or audio production environment. Internal distribution allows a simple video and/or audio connection without any external devices or cables, other than the network output cable.

Typically, the network output cable is connected to a nearby Ethernet network that would in turn be connected to the Internet or to a private intranet. The system would convert the single video and/or audio input into three streams of video and/or audio data, suitable for live web casting, which in typical use is then forwarded to a streaming server located elsewhere on the Internet or intranet, and there they are replicated for multiple simultaneous users to access and receive the video and/or audio program on their computers. A custom software user interface immediately asks the user to select the desired stream types. Typically three different speeds can be chosen by the user to reach users that have different speeds of connection to the Internet or intranet, such as dial-up modem, ISDN or low level broadband, and medium level broadband suitable for cable-modems, DSL modems, or corporate networks.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A system for providing digital programs over the world wide web, the system comprising:
a device having a storing means for storing one or more digital programs provided by an owner of the rights to the digital programs;
ordering means for ordering one or more digital programs by a user from a web site through the device, the web site not having rights to the digital programs; and
authorization means for obtaining authorization for the user from the owner to obtain the ordered one or more digital programs; and
wherein the one or more digital programs ordered by the user are streamed from the device directly to the user.

2. The system for providing digital programs over the world wide web according to claim 1, further comprising:
purchasing means for purchasing the one or more digital programs.

3. The system for providing digital programs over the world wide web according to claim 1, further comprising:
billing means for providing payouts to the owner and the web site based on amounts or percentages the owner and the web site are to receive.

4. The system for providing digital programs over the world wide web according to claim 1, wherein the storing means comprises one or more servers.

5. The system for providing digital programs over the world wide web according to claim 1, wherein the ordering means comprises an online order form.

6. The system for providing digital programs over the world wide web according to claim 1, wherein the authorization means is part of the device.

7. The system for providing digital programs over the world wide web according to claim 1, wherein the one or more digital programs are video programs.

8. The system for providing digital programs over the world wide web according to claim 1, wherein the one or more digital programs are audio programs.

9. The system for providing digital programs over the world wide web according to claim 1, wherein the one or more digital programs are video and audio programs.

10. The system for providing digital programs over the world wide web according to claim 1, wherein the user orders from the web site through a referral web site.

11. A method for providing digital programs over the world wide web, the method comprising:
storing one or more digital programs provided by an owner of the rights to the digital programs in a device;
providing an ordering means to a user to order one or more digital programs from a web site through the device, the web site not having rights to the digital programs;
obtaining authorization for the user to obtain the ordered one or more digital programs; and
streaming the one or more digital programs ordered by the user from the device directly to the user.

12. The method for providing digital programs over the world wide web according to claim 11, further comprising:
purchasing the one or more digital programs.

13. The method for providing digital programs over the world wide web according to claim 11, further comprising:
providing payouts to the owner and the web site based on amounts or percentages the owner and the web site are to receive.

14. The method for providing digital programs over the world wide web according to claim 11, further comprising:
referring the user to the web site through a referral web site.

15. The method for providing digital programs over the world wide web according to claim 11, wherein one or more servers store the one or more digital programs.

16. The method for providing digital programs over the world wide web according to claim 11, wherein an online order form is used to order the one or more digital programs.
